(19) United States
(12) Patent Application Publication
(10) Pub. No.: US 2005/0096030 A1
(43) Pub. Date: May 5, 2005

(54) Wireless device remote control by DTMF commands

(75) Inventors: Ralph W. Boyd, Southwest Ranches, FL (US); Mark A. Goldberg, Davie, FL (US); Charbel E. Hayek, Plantation, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/696,756

(22) Filed: Oct. 29, 2003

(51) Int. Cl. H04Q 7/00

(52) U.S. Cl. 455/419; 455/458

(57) ABSTRACT

A wireless communications device, such as a cellular telephone (200), is able to accept and process DTMF tones as commands. Appropriate DTMF tones control operating characteristics of the wireless communications device (200). An example is causing a cellular phone to ring even though it has been configured into a “vibrate only” silent ring mode or a mode which has disabled all incoming call notification. Operation of such a DTMF tone facilitates finding a lost or misplaced cellular phone when that phone is configured to not ring in response to other calls. An external data communications port (232) of the wireless communications device (200) can also be controlled or data specified by the DTMF tone can be transmitted out of that data communications port (232).

### FIELD OF THE INVENTION

The present invention generally relates to the field of wireless communications devices and more particularly to remote control of functions or features of those wireless communications devices.

### BACKGROUND OF THE INVENTION

Portable communications devices, such cellular telephones, are easily left in out of the way or hidden places within a person's house or workplace. Users of such devices sometimes forget where the device was left and must spend time looking for it. It is normally possible to locate the wireless device by placing a call to the device, so as to cause the device to ring or trigger an alert, such as flashing lights or other observable indicators. The user of the device is then able to locate the device by listening for the ring or searching for the alert. A problem with this technique is that wireless communications devices are often able to be placed into a “silent” alert mode, where the device only vibrates upon receipt of an incoming call, or the device is able to be configured to disable incoming call alerts altogether. When the wireless communications device is placed into such a mode, placing a call to the device will not cause the device to provide an audible or otherwise observable indication that allows the device to be more easily located. This greatly increases the effort needed to locate the wireless communications device, since a physical search of all possible locations is needed to find the device.

Therefore a need exists to overcome the problems with the prior art as discussed above.

### SUMMARY OF THE INVENTION

According to a preferred embodiment of the present invention, a wireless communications device has a DTMF receiver for receiving at least one DTMF tone over a communications channel at the wireless communications device. The wireless communications device also has a DTMF protocol processor for controlling, in response to the at least one DTMF tone, an operating characteristic of the wireless communications device.

According to another aspect of the present invention, a method includes receiving at least one DTMF tone at a wireless communications device and controlling, in response to the at least one DTMF tone, an operating characteristic of the wireless communications device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary wireless communications network that incorporates embodiments of the present invention.

FIG. 2 is a circuit block diagram for a cellular phone according to a preferred embodiment of the present invention.

FIG. 3 is a DTMF detector block diagram as included in the cellular phone illustrated in FIG. 2 according to a preferred embodiment of the present invention.

FIG. 4 is a processing flow diagram for performing remote control of a wireless communications device according to a preferred embodiment of the present invention.

FIG. 5 is a data communications interconnection diagram according to a preferred embodiment of the present invention.

FIG. 6 is a component module diagram for software and data modules contained within a host processor of the cellular phone illustrated in FIG. 2 according to a preferred embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to a preferred embodiment, overcomes problems with the prior art by providing a wireless communications device and a method for controlling a wireless communications device that allows a user from a remote telephone to command the wireless communications device to produce an observable indication, such as ringing or flashing lights, in response to at least one DTMF tone issued over a communications channel (such as a control or voice channel). The exemplary embodiments of the present invention advantageously allow a person to use any readily available telephone to cause a misplaced wireless communications device to ring or provide an observable indication to facilitate location of that device.

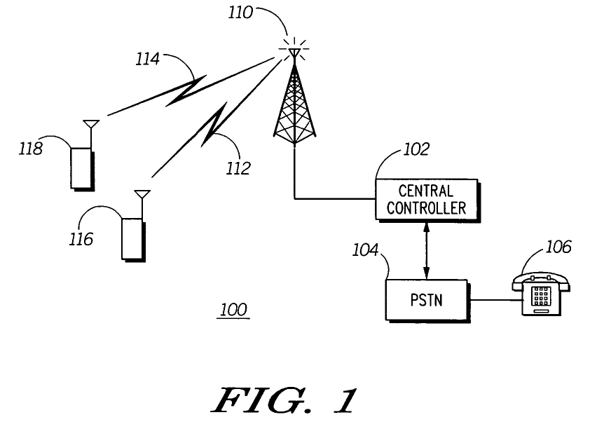

An exemplary wireless communications network 100 that incorporates embodiments of the present invention is illustrated in FIG. 1. The exemplary wireless communications network 100 incorporates at least one wireless communications base station 110 that is in wireless communications with one or more wireless communications devices, such as Cell Phone A 118 and Cell Phone B 116. Cell Phone A 118 is in wireless communications with base station 110 over Wireless Link A 114 and Cell Phone B 116 is in wireless communications with base station 110 over Wireless Link B 112. Embodiments of the present invention utilize wireless links that include optical communications links, communications via satellite and/or terrestrial wireless links and other wireless digital and/or analog links as are known in the relevant arts.

The wireless base station 110 of the exemplary embodiment is in communication with a central controller 102. Central controller 102 performs wireless network control and is connected to, and controls wireless communications through, multiple wireless base stations such as the exemplary wireless base station 110. The Central Controller 102 monitors wireless communications devices that are in communications with wireless communication devices, such as Cell Phone A 118 and Cell Phone B 116. The Central Controller 102 of the exemplary embodiment configures wireless communications circuits to wireless communications devices by either accepting call requests and other control message packets from the wireless communications devices or by transmitting call initiation requests to the wireless communications devices. Central controller 102 of the exemplary embodiment sends control message packets to wireless communications devices in order to control the operation of those devices.

Central controller 102 also connects to the Public Switched Telephone Network (PSTN) 104. The connection to the PSTN 104 allows connection between the wireless network and the commonly available wired telephone system. PSTN 104 allows connection to a wired telephone 106 in the exemplary embodiment. It is to be understood that PSTN 104 allows connection to wired telephones located around the world as well as connections to other wireless communications systems. Alternative embodiments of the present invention implement connections between Central Controller 102 and other communications systems, such as other wireless communications systems and/or wired communications systems that have limited accessibility, such as Private Branch Exchanges (PBXs). In the exemplary embodiment, wired telephone 106 is used to send DTMF tones that are DTMF commands to a wireless communications device, such as cell phone A 118.

Central Controller 102 of the exemplary embodiment controls and monitors wireless communications devices, such as Cell Phone A 118, by transmitting and receiving service message packets to and from the wireless communications devices. Central Controller 102 also acts as a communications node for voice and/or data communications between a wireless communications device, such as cell phone A 118, and another communications end node. Examples of data and/or voice communications from Cell Phone A 118 include voice communications between Cell Phone A 118 and the wired telephone 106. Another example is voice and/or data communications between Cell Phone A 118 and Cell Phone B 116. Control of the wireless communications network to implement either of these examples, and transfer of voice and/or data between Cell Phone A 118 and another end node, are all handled by Central Controller 102 in the exemplary embodiment. Some embodiments of the present invention include a Central Controller 102 that is distributed among several data and voice processors that are able to be physically and even geographically dispersed to accommodate the requirements of the wireless communications network.

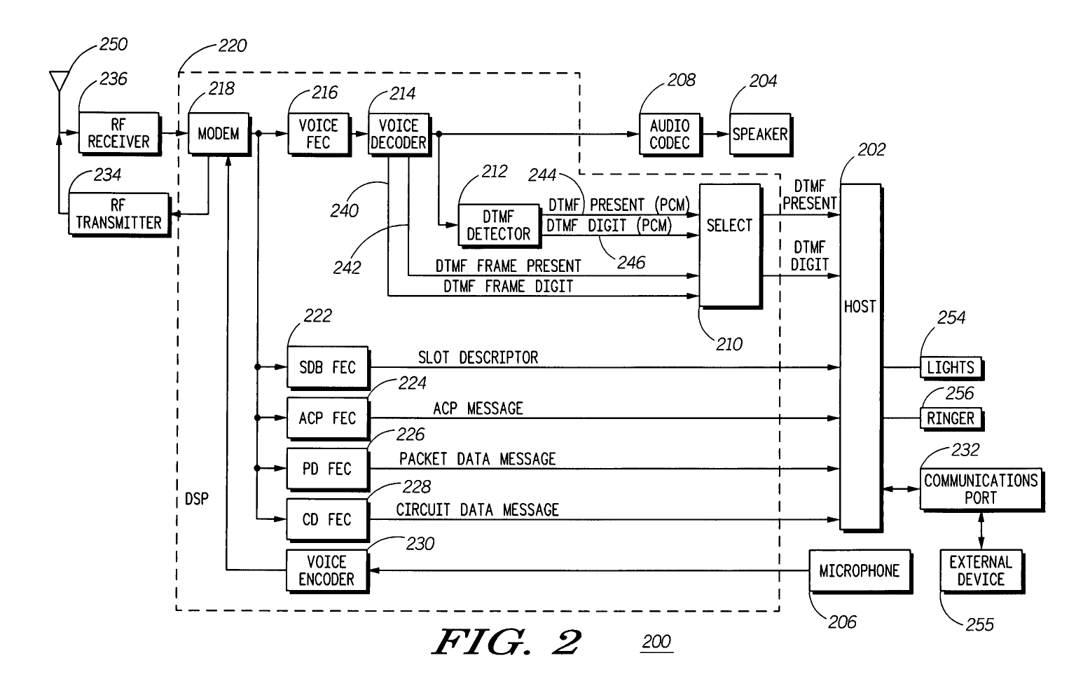

A circuit block diagram 200 for a cellular phone according to a preferred embodiment of the present invention is illustrated in FIG. 2. The exemplary cellular phone supports voice and data communications and performs voice communications by digitizing and encoding voice signals for transmission over a digital wireless communications link. The exemplary cellular phone includes an RF receiver 236 and an RF transmitter 234 to support bi-directional communications over an RF link, such as Wireless Link A 114. The exemplary cellular phone also includes a Digital Signal Processor (DSP) 220, which is a special purpose data processor that performs most of the signal processing required by the operation of the cellular phone. DSP 220 includes a modem processing module 218. The modem processing module 218 of the exemplary embodiment is a software based processing module that performs data modulation and demodulation processing to support data communications through the RF receiver 236 and RF transmitter 234. The modem processing module of the exemplary embodiment accepts encoded voice data from the voice encoder processing module 230 for modulation and transmission. The modem processing module also produces demodulated data that is derived from received RF signals as received by the RF receiver 236.

The exemplary cellular phone 200 includes a host processor 202, which is a general purpose microprocessor that is programmed to control the operation of the exemplary cellular phone 200. The host processor 202 handles, for example, establishing, maintaining and terminating incoming and outgoing voice and/or data calls. Host processor 202 of the exemplary embodiment also provides a data interface via communications port 232 to one or more devices (not shown). Devices connected to the host processor 202 by the communications port 232 are able to be internal to the cellular phone or external to the cellular phone and connected via a cable or other suitable connection. Host processor 202 contains a number of software based processing modules that are described in detail below.

The modem processing module 218 contained within the DSP 220 provides demodulated received data to a number of processing modules that operate within the DSP 220 of the exemplary embodiment. Data processed by the modem processing module 218 includes data communicated via packet data and circuit data networks. The modem processing module 218 of the exemplary embodiment is further able to demodulate signals, which are able to convey DTMF information, that are communicated over an associated communications channel (such as a control or voice channel).

Data communicated to and from the exemplary cellular phone over a wireless link includes conventional Forward Error Correction (FEC) encoding to improve the robustness of the wireless data link. Demodulated data that is produced by the modem processing module 218 is provided to an appropriate FEC decoder to prepare the received data for processing. The modem 218 and the various FEC decoders that are included in the exemplary embodiment operate in a manner similar to conventional modems and FEC decoders found in similar cellular phones that are known in the relevant arts. The demodulated data produced by the modem 218 of the exemplary embodiment is transferred to a Circuit Data FEC decoder 228, a Packet data FEC decoder 226, an ACP FEC decoder 224, a Slot Descriptor Block FEC decoder 222 or a voice FEC decoder depending upon the data type. The data from the Circuit Data FEC decoder 228, the Packet data FEC decoder 226, the ACP FEC decoder 224, and the Slot Descriptor Block FEC decoder 222 of the exemplary embodiment is provided to appropriate processes within the host processor 202 for processing.

Transmissions begin with a Slot Descriptor Block that is decoded by the Slot Descriptor Block FEC decoder 222. The contents of the Slot Descriptor Block describe the type of data contained in the transmission. Data in the Slot Descriptor Block is used to determine the FEC decoder to use to process the other data in the transmission.

Demodulated data that is provided to the Voice FEC decoder 216 includes received audible voice channel information that is normally played through speaker 204 for the user to hear. DTMF information consists of a pair of audible tones that are chosen from a table of possible tones so as to indicate one of sixteen possible states. This is equivalent to each DTMF tone pair conveying four data bits.

Audible voice channel information that is processed by the Voice FEC decoder 216 is also encoded using conventional techniques, such as those used by vocoders, to reduce the number of data bits that are required to convey the audible information. The vocoder of the exemplary embodiment processes DTMF information that is communicated in one of two manners. DTMF signals are able to be conveyed as two audible tones that are communicated through conventional vocoding. DTMF signals are alternatively able to be transmitted as special DTMF frames within the protocol used by the vocoding process. The use of DTMF frames is particularly useful in communications between two cell-phones that use the same vocoding protocol, or in cases in which an element of the system, such as central controller 102, processes incoming DTMF information prior to transmission to wireless devices. In the exemplary embodiment, DTMF frames are special data packets that contain a frame identifier and a payload portion. The frame identifier indicates that the frame is a DTMF frame and the payload portion indicates the four bits conveyed within the DTMF information.

If a DTMF frame is present on the audio channel, a DTMF frame present indicator 242 and a four bit DTMF frame digit data 240 are produced by the voice decoder 214 and provided to data selector 210. If an encoded speech frame is detected, the output of the voice decoder 214 is then processed by DTMF detector 212. DTMF detector 212 produces a DTMF present indicator 244 and a four bit DTMF digit data 246 if a DTMF frame is decoded (described in more detail below). This data is provided to selector 210. In the exemplary embodiment, the selector 210 accepts decoded DTMF information either: from the DTMF Frame Digit 240, if the DTMF frame Present 242 signal is asserted; or from the DTMF Digit (PCM) 246, if the DTMF Present (PCM) signal is asserted. If either the DTMF Frame Present 242 or the DTMF Present (PCM) is asserted, the selector 210 provides a DTMF present indicator and a four digit DTMF digit to appropriate processes that are executing in the host processor 202. In the exemplary embodiment, the DTMF detector 212 and voice decoder 214 are part of a DTMF receiver that is used to receive at least one DTMF tone over a voice channel. In further embodiments, the DTMF tone is received over a control channel.

The output of Voice Decoder 214 is also provided to an audio Codec 208 to further process the data and recover analog voice signals to drive speaker 204 and provide an audible signal for the user of cellular phone 200. Microphone 206 is used to produce an analog electrical signal representing audible signals, such as the user's voice. The electrical signals produced by microphone 206 in the exemplary embodiment are provided to voice encoder 230, where they are processed by conventional techniques into an appropriate compressed data stream for modulation by the modem 218 and transmission through RF transmitter 234 via antenna 250.

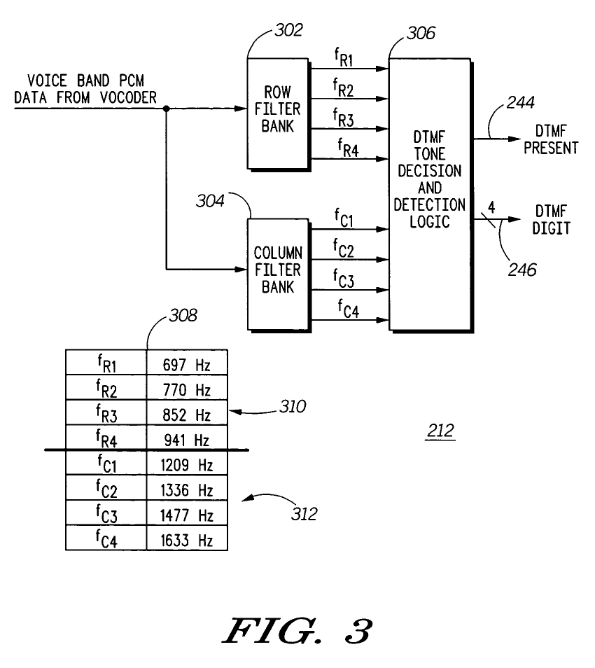

A block diagram of a DTMF detector 212 as included in the cellular phone 200 according to a preferred embodiment of the present invention is illustrated in FIG. 3. The DTMF detector 212 of the exemplary embodiment uses conventional processing techniques that are performed by software based processing modules operating in DSP processor 220 to produce a DTMF present indicator 244 and a four bit DTMF digit data 246. The DTMF data provided as an input to the DTMF detector conveys a pair of tones that are selected from tone table 308. One of the tones in the tone pair is selected from the “row” tones 310 which consist of f_{R1} through f_{R4}. The other tone of the one pair is selected from the “column” tones 312 which consist of f_{C1} through f_{C4}. Voice band Pulse Code Modulation (PCM) data, which is a digitized representation of the voice band signal received by the cell phone 200, is received from the Voice Decoder 214 in the exemplary embodiment and is provided to a DSP implementation of a row filter bank 302 and a column filter bank 304. The row filter bank 302 identifies which, if any, row tones 310 are present on the received voice band PCM data. The column filter bank 304 similarly identifies which, if any, column tones 312 are present on the received voice band PCM data. Indications of a detection of any of these tones are provided to the DTMF tone decision and detection logic 306 of the exemplary embodiment, which incorporates conventional processing to derive a DTMF present indicator 244 and a four bit DTMF digit data 246.

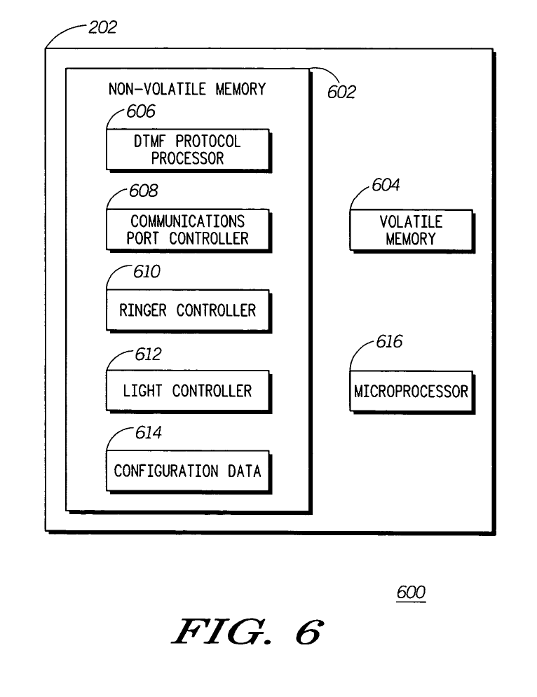

A component module diagram 600 for software and data modules contained within host processor 202 of the cellular phone 200 according to a preferred embodiment of the present invention is illustrated in FIG. 6. Host processor 202 contains volatile memory 604 that is used to store transient data that is used by the cellular phone 200. Host processor 202 further contains non-volatile memory 602 that contains firmware components that define the processing performed by the host processor 202. The firmware components that are relevant to the operation of the exemplary embodiment of the present invention are a DTMF protocol processor 606, communications port controller 608, ringer controller 610 and light controller 612. Non-volatile memory 602 further contains configuration data 614 that defines configuration of customizable features of the cellular phone. Processor or controller 616 that is contained within host processor 202 of the exemplary embodiment executes the firmware components.

DTMF protocol processor 606 of the exemplary embodiment accepts decoded DTMF data produced by selector 210 of the exemplary embodiment. DTMF protocol processor 606 determines if received DTMF signals contain valid DTMF commands that are to be acted upon and used to control an operating characteristic of the wireless communications device. The Communications port controller 608 controls the operation and data transferred through communications port 232 of the wireless communications device. The communications port controller 608, for example, will transfer a data string out of the communications port 232 in response to a DTMF command to do so. The Ringer controller 610 and light controller 612 control audible ringer 256 and lights 254, respectively.

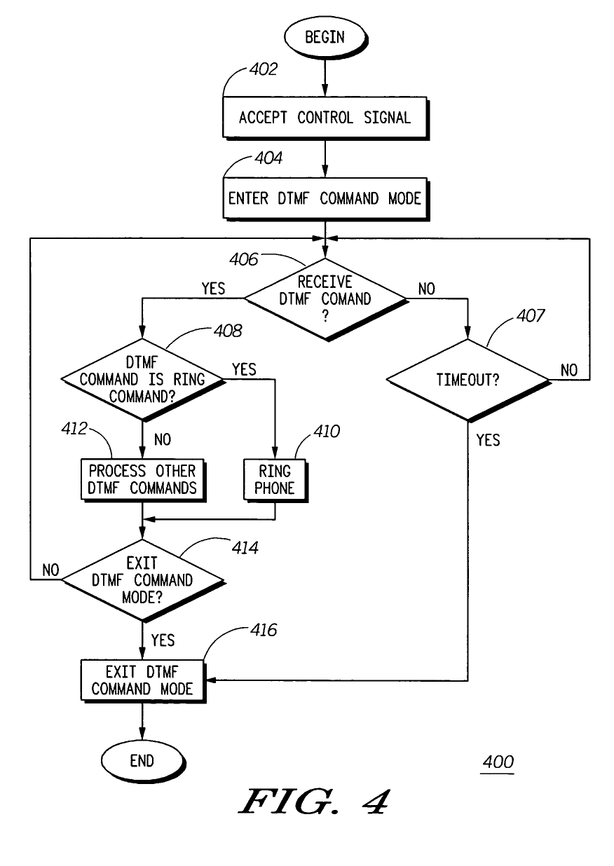

A processing flow diagram 400 for performing remote control of a wireless communications device according to a preferred embodiment of the present invention is illustrated in FIG. 4. The processing begins by accepting, at step 402, a control signal to cause the wireless communications device to enter a DTMF command mode. The cell phone that is the wireless communications device of the exemplary embodiment is configured into an “auto-answer” mode where any incoming call is automatically answered without user intervention. The preferred embodiment is therefore able to use a conventional ring signal from the base station 110 to initiate DTMF control mode since the phone will automatically answer the incoming call. Once the phone has answered the incoming call, a voice channel is established to the phone and DTMF tones are able to be received, detected and processed.

Some embodiments of the present invention do not use a wireless communications device that is in “auto-answer” mode and use unique signals, such as special packet data commands, special ring sequences or ring patterns, that are sent from the base station 110 and that are processed and recognized by the host processor 202 to control the wireless communications device. These embodiments recognize these unique signals and some of these embodiments respond by putting the wireless communications device into an auto-answer mode or by causing the device to “answer” the call and establish a voice channel. Some embodiments also have a special telephone number that is accessed by callers that causes the base station to send a control signal to the wireless communications device to immediately answer the call and establish a voice or control channel with the wireless communications device over which DTMF commands may be sent. The control signal may also be configured to include DTMF tones that are DTMF commands that are to be sent over the voice or control channel in order to enter DTMF command mode.

Once a control signal has been accepted by the wireless communications device, the processing enters, at step 404, DTMF command mode. In DTMF command mode, the wireless communications device will process DTMF commands that are sent over the voice or control channel to the wireless communications device and perform an appropriate control function on the wireless communications device. The processing of the exemplary embodiment also begins a timer upon entry into DTMF command mode to allow determination of the time that the device is in DTMF command mode and detection of a timeout, as is described below.

Once in DTMF command mode, the processing determines, at step 406, if a DTMF command has been received. A DTMF command in the exemplary embodiment is one or more DTMF digits that are transmitted to the wireless communications device over a voice channel that is established with the device. If it is determined that a DTMF command has not been received, the processing advances to determine, at step 407, if a timeout for the DTMF command mode has occurred. The exemplary embodiment is able to be configured with a maximum time in which to remain in DTMF command mode or, alternatively, with a maximum idle time. Idle time in this embodiment is determined by the time after the last DTMF command that was received. The timer that was started upon entry into DTMF command mode is examined in this step to determine if the maximum configured time has elapsed. If the maximum amount of time to remain in DTMF command mode has not elapsed, the processing returns to determine, at step 406, if a DTMF command has been received. If the maximum amount of time to remain in DTMF command mode has elapsed, the processing advances to exiting, at step 416, DTMF processing mode, as is described below.

If it is determined that a DTMF command has been received, the processing of the exemplary embodiment determines, at step 408, if the DTMF command is a “Ring” command. A DTMF “Ring” command in the exemplary embodiment consists of the digit “7,” which corresponds to the letter “R” on a conventional telephone. If the DTMF command is the “Ring” command, the processing advances to change a ring mode of the wireless communications device that includes providing an observable indication by ringing, at step 410, the wireless communications device. More complex sequences of DTMF digits are also able to be used as a DTMF command, such as the “Ring” command.

Ring modes for the wireless communications device of various exemplary embodiments of the present invention that are entered upon receipt of a DTMF tone that is a DTMF “ring” command include providing observable indications that include, without limitation, one or more of an audible sound or series of sounds, flashing lights or other visual effects and so on. In one embodiment, a variety of different observable indications is provided in response to different DTMF commands, such as defining different DTMF commands to cause ringing and flashing lights.

If the DTMF command was not determined to be a “Ring” command, the processing advances to process, at step 412, other DTMF commands. Other DTMF commands are able to consist of one or more DTMF digits that cause other commands or reconfiguration of the wireless communications device. Examples include, but are not limited to, control of the communications port 232, providing data output through the communications port 232, or reconfiguration of other operating parameters of the wireless communications device. Control of the communications port includes disabling or enabling operation of the port. Data that is provided as output through communications port 232 is able to, for example, turn a device connected to the port on or off. Some embodiments of the present invention support DTMF commands that cause the wireless communications device to exit “silent ring” mode so that the device will provide an observable indication upon receipt of an incoming call. When such a command is sent to the wireless communications device, a subsequent call will cause the device to provide an observable indication, such as a ring and/or flashing lights, to facilitate location of the device.

After processing the DTMF command, the processing determines, at step 414, if the processing is to exit DTMF command mode. The exemplary embodiment of the present invention is able to be configured to exit DTMF command mode after one or a specified number of DTMF commands have been processed. Embodiments that are not configured to exit DTMF command mode once a maximum number DTMF commands are processed can rely upon the timeout processing described above to cause the wireless communications device to exit from the DTMF command mode. Some embodiments of the present invention further allow any criteria to be set to control the determination to exit DTMF command mode, such as a special DTMF command. If the processing is not to exit from the DTMF command mode, the processing returns to accept, at step 406, a DTMF command, as is described above.

After the processing determines that it is to exit DTMF command mode, either based upon timeout, configuration or other criteria, the processing exits, at step 416, DTMF command mode. Exiting DTMF command mode consists of a configurable sequence of steps in the exemplary embodiment, including termination of the voice channel to the wireless communication device. After exiting DTMF command mode, the processing of the exemplary embodiment ends.

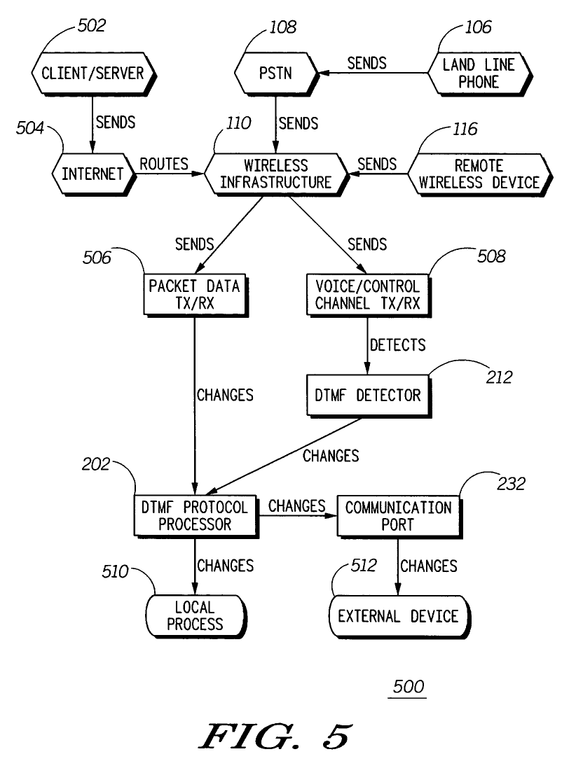

A data communications interconnection diagram 500 according to a preferred embodiment of the present invention is illustrated in FIG. 5. The exemplary embodiment is able to allow DTMF commands to originate from a variety of sources. The exemplary embodiment advantageously allows these multiple sources to utilize commonly available DTMF tone generators to command and otherwise control a wireless communications device over a voice or control channel without additional equipment.

DTMF commands are able to originate from a Land Line Phone 106. The Land Line Phone 106 sends DTMF commands over a voice channel through the Public Switched Telephone Network (PSTN) 108. The PSTN 108, in turn, sends these DTMF commands to a wireless infrastructure, including base station 110, that is associated with the wireless communications device that is to receive the command. The wireless infrastructure 110 is similarly able to receive DTMF commands from other remote wireless devices 116, as well as from a client server 502 over the Internet 504. Transmission of DTMF commands over the internet can be performed, for example, by digitizing audio that is sent to the wireless infrastructure.

The wireless infrastructure is then able to send DTMF commands either through packet data 506, or through a voice/control channel 508 as is described above. DTMF commands transmitted through packet data 506 are communicated to the DTMF protocol processor, which is a process executing within host processor 202 in the exemplary embodiment. DTMF commands transmitted via a voice/control channel are processed through DTMF detector 212 and then delivered to the DTMF protocol processor executing within host processor 202. The DTMF protocol processor of the exemplary embodiment then provides the appropriate control and/or data output to either a local process 510, which includes ringing of the phone's ringer, or to a communications port 232. DTMF commands can be used to control the communications port 232 or to provide data that is to be sent out the communications port 232 to external device 512.

Alternative embodiments of the present invention incorporate wireless communications devices that can be commanded through the wireless infrastructure to provide an observable indication, such as audibly ringing the phone or flashing lights. These embodiments provide the advantage of the present invention by allowing users from remote telephones, such as a land line phone 106 or a remote wireless device 116, to call the central server and provide DTMF commands that are interpreted by the central server to send a command to a wireless communications device to cause that device to ring. These embodiments can also allow users of digital devices, such as wireless phones or computers, to send DTMF commands to the central server for relay to the wireless communications device. This allows a person using an ordinary phone to trigger an observable indication to be produced by a misplaced wireless communications device in order to facilitate location of that device.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method for controlling a wireless device, the method comprising the steps of:
receiving at least one DTMF tone over a communications channel at the wireless communications device; and
controlling, in response to the at least one DTMF tone command, an operating characteristic of the wireless communications device.

2. The method according to claim 1, wherein the controlling step comprises making at least one observable indication emanate from the wireless communications device.

3. The method according to claim 2, wherein the observable indication comprises an audible ring.

4. The method according to claim 2, wherein the observable indication comprises an illumination of at least a portion of the wireless communications device.

5. The method according to claim 1, wherein the controlling step comprises changing a ring mode of the wireless communications device.

6. The method according to claim 1, wherein the controlling step comprises controlling a communications port of the wireless communications device.

7. The method according to claim 1, wherein the controlling step comprises transferring data out of a communications port of the wireless communications device.

8. A wireless communications device, comprising:
a DTMF receiver for receiving at least one DTMF tone at the wireless communications device; and
a DTMF protocol processor for controlling, in response to the at least one DTMF tone, an operating characteristic of the wireless communications device.

9. The wireless communications device according to claim 8, wherein the DTMF protocol processor makes at least one observable indication emanate from the wireless communications device.

10. The wireless communications device according to claim 9, wherein the observable indication comprises an audible ring.

11. The wireless communications device according to claim 9, wherein the observable indication comprises an illumination of at least a portion of the wireless communications device.

12. The wireless communications device according to claim 8, wherein the DTMF protocol processor further changes a ring mode of the wireless communications device.

13. The wireless communications device according to claim 8, wherein the DTMF protocol processor further controls a communications port of the wireless communications device.

14. The wireless communications device according to claim 8, wherein the DTMF protocol processor further transfers data out of a communications port of the wireless communications device.

15. The wireless communications device according to claim 8, further comprising a packet data receiver for receiving the at least one DTMF tone.

16. The wireless communications device according to claim 8, further comprising a circuit data receiver for receiving the at least one DTMF tone.

17. The wireless communications device according to claim 8, further comprising an associated control channel receiver for receiving the at least one DTMF tone.

18. A computer program product comprising computer programming instructions for controlling a wireless device, the computer programming instructions comprising instructions for:
receiving at least one DTMF tone over a communications channel at the wireless communications device; and
controlling, in response to the at least one DTMF tone, an operating characteristic of the wireless communications device.

19. The computer program product according to claim 18, wherein the instructions for controlling comprise instructions for making at least one observable indication emanate from the wireless communications device.

20. The computer program product according to claim 19, wherein the observable indication comprises an audible ring.

21. The computer program product according to claim 19, wherein the observable indication comprises an illumination of at least a portion of the wireless communications device.

22. The computer program product according to claim 18, wherein the instructions for controlling comprise instructions for changing a ring mode of the wireless communications device.

23. The computer program product according to claim 18, wherein the instructions for controlling comprise instructions for controlling a communications port of the wireless communications device.

24. The computer program product according to claim 18, wherein the instructions for controlling comprise instructions for transferring data out of a communications port of the wireless communications device.
